(19) United States
(12) Patent Application Publication
(10) Pub. No.: US 2014/0053519 A1
(43) Pub. Date: Feb. 27, 2014

(54) DEVICE FOR COMBUSTION AND PURIFICATION TREATMENT OF AUTOMOBILE SMOKY EXHAUST

(71) Applicant: WEN-LO CHEN, Taipei City (TW)

(72) Inventor: WEN-LO CHEN, Taipei City (TW)

(21) Appl. No.: 13/596,025

(22) Filed: Aug. 27, 2012

(51) Int. Cl. B01D 50/00

(52) U.S. Cl. 55/385.3

(57) ABSTRACT

Disclosed is an improved device for combustion and purification treatment of automobile smoky exhaust, which includes, in sequence between an inlet end and an outlet end of an exhaust pipe, a combustion system and an exhaust buffering and filtration system. Exhaust gas, when passing through the combustion system, is forced to divide and individually flow through a plurality of gas channels. A fuel atomization nozzle that cannot be blown off by exhaust flow injects and atomizes fuel. An igniter ignites the fuel. The exhaust gas passing through the gas channels induces a siphon effect to draw heat from the chamber after the combustion to mix with the exhaust gas so as to increase the temperature of the exhaust gas. An exhaust buffering unit reduces the flowing speed of the exhaust gas. The high temperature exhaust gas then cause carbon deposit to combust so as to eliminate the carbon deposit.

### (a) TECHNICAL FIELD OF THE INVENTION

The present invention generally relates to elimination of carbon deposit inside a filter device installed at a rear end section of au automobile exhaust pipe in order to maintain smooth discharge of exhaust from a diesel engine.

### (B) DESCRIPTION OF THE PRIOR ART

The exhaust gas discharged from a diesel automobile, after passing through a filter system, builds up carbon deposit in a filter core of the filter system. Once reaching a predetermined thickness, the carbon deposit causes clogging, which in turn leads to rise of internal pressure (back pressure) of the exhaust pipe. Currently, the automobile industry often installs a back pressure sensor inside the engine exhaust pipe of a diesel automobile to detect the pressure level of the filter core of the filter system so as to identify clogging caused by the carbon deposit. Once the carbon deposit caused by exhaust gas from the engine of the diesel automobile passing through the filter core of the filter system reaches a predetermined thickness and thus blocks the flow of exhaust gas, an increase of the back pressure of the exhaust will be detected. Under such a condition, an engine management system issues a signal to increase operation temperature of the engine to combust and thus eliminate the carbon deposit built up on a filtering surface of the filter system in order to remove the clogging. However, due to the poor environment of driving automobile (such as in a metropolitan area), where automobiles often needs to frequently stop during the travel thereof, or due to incorrect driving practice of individual drivers (such as driving for short distance or not often traveling with highways) that constantly keeps the automobile traveling in idle condition, the diesel automobile installed with such a filter system may not properly operate to increase the operation temperature of the engine because the engine revolution is always kept low, whereby the carbon deposit on the filter core surface of the filter system cannot be properly combusted and eliminated. This not only affects filtering of exhaust gas from the diesel engine but also affects the normal operation of the diesel engine. Once this happens, the automobile must be properly serviced in a garage where a technician may remove the carbon built up on the filter core surface of the filter system through combustion. This is time-consuming, uneconomic, and troublesome.

In Europe and America, to meet the standard set up in environmental protection related regulations, a common rail computer based ignition system is adopted to improve exhaust of toxicant gas (CO, HC, NOx, Sox) and smoky particles. Besides a honeycomb ceramic filter core being used, a minor amount of diesel may be added at the outlet of an engine valve to raise the combustion temperature in order to provide a sufficiently high combustion temperature to combust off the deposited particles on the filter core. Or alternatively, a minor amount of diesel is added to the exhaust pipe at a location close to the filter core in order to increase the internal temperature of the filter core. These arrangements are designs that are bonded with the originally designed electronics of the automobiles. For an already existing automobile, to add these arrangements, modification must be made and this will change the original configuration of the automobile and probably unexpected difficult will be encountered in future maintenance of the automobile. This is economically and practically poor and is not idea for further popularization.

Taiwan Utility Model M362299 issued to the present applicant discloses a device for treating and instantaneously combusting and purifying smoky exhaust from a diesel automobile, wherein a combustion system and a filter system are sequentially arranged inside an exhaust pipe from an inlet end toward an outlet end. When a first pressure sensor detects an exhaust pressure inside the exhaust pipe exceeding a predetermined threshold, a microcomputer control system issues an fuel injection signal to a fuel tank so that the fuel tank supplies fuel to a combustion nozzle arranged inside the combustion system, while an ignition device is simultaneously activated to inject the fuel into the combustion system and simultaneously ignite the fuel for combustion and heating to around 400° C. The gas that is heated to a high temperature is conducted through the filter system to combust and eliminate the carbon deposit. Once a second pressure sensor detects that the exhaust gas pressure is lower than a predetermined level, the microcomputer control system automatically shut down the supply of fuel from the fuel tank, allowing the exhaust of the diesel engine to naturally pass through the filter system for discharging, so that smooth discharge of the exhaust from the diesel engine can be maintained. The Utility Model M362299 arranges the ignition device in the path where the exhaust flow passes and thus, the flame induced by an ignition operation may be blown off by the flow, leading to incomplete combustion of the carbon deposit of the filter system.

### SUMMARY OF THE INVENTION

The primary object of the present invention is to solve the problem that in a conventional diesel engine automobile that comprises a filter system installed in an exhaust pipe, a device that combusts deposited carbon off a filter core surface of a filter system by raising the operation temperature of engine may fail to raise the engine operation temperature simply due to engine revolution being not increased as a consequence of traveling environment or driving condition of the automobile or driving practice of individual driver, so as not to properly burn off carbon deposited on the filter core surface, resulting in that the carbon deposit remains and smooth discharge of exhaust and diesel engine performance are affected.

Another object of the present invention is to overcome the problem that in Taiwan Utility Model M362299, an ignition device is installed on the path of an exhaust flow channel so that the flame may be easily blown off by the flow thereby causing incomplete combustion of the carbon deposit of the filter system.

The features of the present invention comprises, in sequence between an inlet end and an outlet end of an exhaust pipe, a combustion system and an exhaust buffering and filtration system. Exhaust gas, when passing through the combustion system, is forced to divide and individually flow through a plurality of gas channels. A fuel atomization nozzle that cannot be affected and blown off by exhaust flow injects and atomizes fuel. An igniter ignites the fuel. The exhaust gas passing through the gas channels induces a siphon effect to draw heat from the chamber after the combustion for being mixed with the exhaust gas so as to increase the temperature of the exhaust gas.

The high temperature exhaust sequentially passes through an exhaust buffering unit and a filter unit of the exhaust buffering and filtration system in such a way that the exhaust buffering unit reduces the flowing speed of the exhaust gas and prevent a reverse flow of the exhaust gas that may blow off the flame and make the exhaust flow uniform to subsequently travel through the filter unit, whereby the high temperature of the exhaust gas may eliminate carbon deposit on the filter unit to ensure smooth discharge of exhaust gas from a diesel engine.

The technical solution that the present invention provides for the combustion system is that an outer tube is provided and an inner tube is arranged inside the outer tube. A chamber body is arranged inside the inner tube. The chamber body defines a chamber in which a fuel atomization nozzle and at least one igniter are arranged. The chamber body comprises chamber walls arranged along a circumference and an end facing the inlet end of the exhaust pipe. A first gas channel is formed between an inside surface of the outer tube and an outside surface of the inner tube. A second gas channel is formed between an inside surface of the inner tube and an outside surface of the chamber body. The fuel atomization nozzle is connected through piping to a pump-operated fuel tank and a solenoid valve is mounted in the piping to control supply of fuel to the fuel atomization nozzle. When exhaust gas from the exhaust pipe passes through the first gas channel and the second gas channel, the electromagnetic valve timely supply a proper amount of fuel to the fuel atomization nozzle to be ejected and atomized thereby. The atomized fuel is then ignited by the igniter to combust inside the chamber. Thus, the exhaust gas passing through the first and second gas channels induces a siphon effect to draw heat from the chamber to be mixed with the exhaust to thereby increase the temperature of the exhaust gas.

The technical solution that the present invention provides for the exhaust buffering and filtration system is that an exhaust buffering unit and a filter unit are sequentially arranged. The exhaust buffering unit comprises an exhaust buffering hood and a volute blade. The exhaust gas passing through the combustion system is conducted sequentially through the exhaust buffering hood and the volute blade for uniformly traveling through the filter unit to be discharged through the outlet end of the exhaust pipe, whereby the uniform and high temperature exhaust gas may combust off the carbon deposit built up on the filter unit.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing the structure of an improved device for purification treatment according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

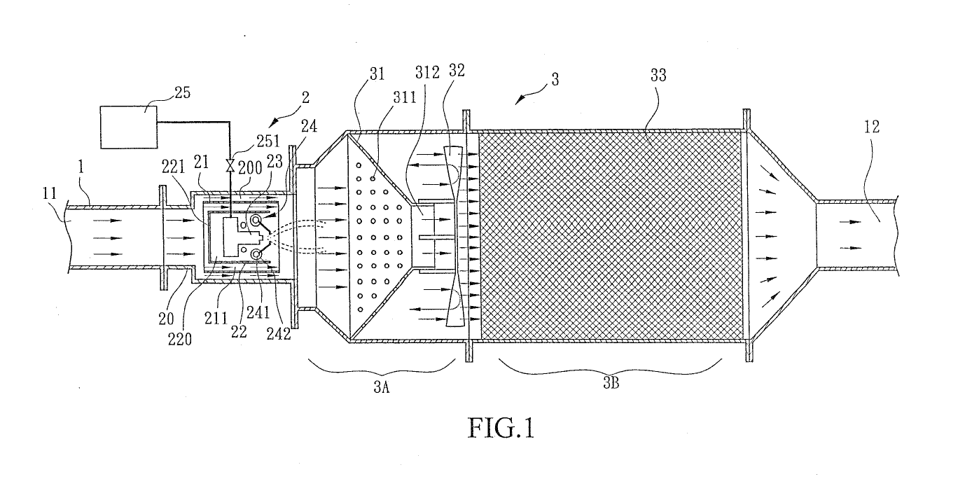

As shown in FIG. 1, the present invention provides an improved device for combustion and purification treatment of automobile smoky exhaust, which comprises a combustion system 2 and an exhaust buffering and filtration system 3 that are sequentially arranged in an exhaust pipe 1 between an inlet end 11 and an outlet end 12. The combustion system 2 comprises an outer tube 20. The outer tube 20 has an end connected to the inlet end 11 of the exhaust pipe. An inner tube 21 is arranged inside the outer tube 20 and a chamber body 22 is arranged inside the inner tube 21. The chamber body 22 comprises chamber walls 221 arranged along a circumference and an end facing the inlet end 11 of the exhaust pipe 1. The chamber walls 221 along the circumference and the end collectively surround a space that forms a chamber 220. A first gas channel 200 is formed between an inside surface of the outer tube 20 and an outside surface of the inner tube 21 and a second gas channel 211 is formed between an inside surface of the inner tube 21 and an outside surface of the chamber body 22. A fuel atomization nozzle 23 and at least one igniter 24 are arranged inside the chamber 220. The fuel atomization nozzle 23 is connected through piping to a pump-operated fuel tank 25 located outside the outer tube 20 and a solenoid valve 251 is installed in the piping. The igniter 24 comprises an insulator 241 and a protective cover 242 housing the insulator 241, whereby the protective cover 242 protects the insulator 241 against carbon deposit built thereon to affect ignition timing.

The exhaust buffering and filtration system 3 comprises an exhaust buffering unit 3A and a filter unit 3B that are sequentially arranged. The exhaust buffering unit 3A comprises an exhaust buffering hood 31 and a volute blade 32 having a specific curved surface. The exhaust gas passing through the combustion system 2 is conducted sequentially through the exhaust buffering hood 31 and the volute blade 32 and then the filter unit 3B to be discharged through the outlet end 12. Preferably, the exhaust buffering hood 31 is a conic hood, which has a conic wall forming a plurality of through holes 311. An exhaust egress opening 312 is formed in a center of the conic hood. The filter unit 3B comprises a honeycomb filter core 33 arranged at an exhaust discharge end of the exhaust buffering unit 3A.

With the improved device for purification treatment according to the present invention described above, in a condition of normal operation, the combustion system 2 is set idle and the exhaust gas from the diesel engine is allowed to directly pass through the first gas channel 200 and the second gas channel 211 of the combustion system 2 and then travel through the exhaust buffering hood 31 and the honeycomb filter core 33, whereby the honeycomb filter core 33 filters off the contaminant substances entraining the exhaust gas and then discharge the filtered exhaust gas. After a lapse of time in operation, the honeycomb filter core 33 gets clogged by carbon deposit, which leads to unsmooth exhaust. In this situation, an operation is carried out to control the system to command a pressurization pump (not shown) of the fuel tank 25 to supply the fuel through piping to the solenoid valve 251 and also to control the activation time of the solenoid valve 251 to feed the fuel to the honeycomb filter core 33 to be jetted and atomized to form tiny particles of fuel. The igniter 24 ignites to cause combustion of the atomized fuel for increasing the internal temperature of the chamber 220 (to around 400° C.). At this moment, the exhaust flows that passes through the first gas channel 200 and the second gas channel 211 induces a siphon effect at the opening of the chamber 220 of the chamber body 22, which draws the high temperature gas inside the chamber 220 out to mix with the exhaust gas. The high temperature exhaust gas so obtained then flows into the exhaust buffering hood 31 to have the moving speed of the exhaust gas properly buffered. The blade curve of the volute blade 32 then guides the exhaust gas flow into the honeycomb filter core 33 in a more uniform manner. The high temperature exhaust gas may then cause the carbon deposited on honeycomb filter core 33 to burn and thus eliminate. When the carbon deposit is eliminated to some extents, the honeycomb filter core 33 restores the smooth and un-clogged condition thereof, allowing the exhaust to be smoothly discharged.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A device for combustion and purification treatment of automobile smoky exhaust, comprising, inside an exhaust pipe sequentially in a direction from an inlet end to an outlet end:
a combustion system, which comprises an outer tube, an inner tube being arranged inside the outer tube, a chamber body being arranged inside the inner tube, a fuel atomization nozzle an at least one igniter being arranged inside the chamber, the chamber body comprising chamber walls along a circumference and an end facing the inlet end of the exhaust pipe, a first gas channel being formed between an inside surface of the outer tube and an outside surface of the inner tube, a second gas channel being formed between an inside surface of the inner tube and an outside surface of the chamber body, the fuel atomization nozzle being connected through piping to a pump-operated fuel tank, a solenoid valve being mounted in the piping; and
an exhaust buffering and filtration system, which comprises an exhaust buffering unit and a filter unit that are sequentially arranged, the exhaust buffering unit comprising an exhaust buffering hood and a volute blade, whereby exhaust gas passing through the combustion system is conducted sequentially through the exhaust buffering hood and the volute blade to allow the exhaust to pass through the filter unit in a uniform manner for subsequently discharging through the outlet end of the exhaust pipe.

2. The device for combustion and purification treatment of automobile smoky exhaust according to claim 1, wherein the exhaust buffering hood is a conic hood, which has a conic wall forming a plurality of through holes, an exhaust egress opening being formed in a center of the conic hood.

3. The device for combustion and purification treatment of automobile smoky exhaust according to claim 1, wherein the filter unit comprises a honeycomb filter core.
